(19) United States
(12) Patent Application Publication
(10) Pub. No.: US 2021/0017796 A1
(43) Pub. Date: Jan. 21, 2021

(54) Door Securing Device

(71) Applicant: Alan Bergman, Melbourne, FL (US)

(72) Inventor: Alan Bergman, Melbourne, FL (US)

(21) Appl. No.: 16/931,384

(22) Filed: Jul. 16, 2020

Related U.S. Application Data
(60) Provisional application No. 62/874,860, filed on Jul. 16, 2019.

(51) Int. Cl. E05C 19/00; E05B 17/20; E05B 47/06; E05B 47/00; G07C 9/33

(52) U.S. Cl. CPC E05C 19/003; E05B 17/2007; E05Y 2900/132; E05B 47/0012; G07C 9/33; E05B 47/06

(57) ABSTRACT

A door locking apparatus and method adapted to allow a person inside an enclosable space to quickly close a door, denying entry into the enclosable space such as a room or building, and enabling such door to be quickly locked from within without any tools or keys and in a one-step motion, such that an unwanted intruder is denied access. The invention comprises a locking post that is received by a receiving structure such a floor or door frame. The locking post of the invention may be of substantial cross section such that unaided forceful entry is prevented. The latch of the invention may be manually operated by the foot or hand of the user. The door locking device is able to be locked or unlocked by a user from within an enclosable space, but can only be unlocked from outside the enclosable space by a key or code.

### CROSS REFERENCE TO RELATED APPLICATIONS AND INCORPORATION BY REFERENCE

This application for patent is a non-provisional of, and claims benefit of priority to, provisional application Ser. No. 62/874,860 titled DOOR SECURING DEVICE, filed in the United States Patent and Trademark Office on Jul. 16, 2019, which is hereby incorporated by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

### 1. Field of the Invention

The field of the invention relates generally to systems and methods for securing doors and other entry barriers such as gates (collectively herein, “doors”). More specifically, the field of the invention relates to systems, devices and methods for securing a door in a lockable manner such that unwanted entry or passage through a doorway may be quickly established, and only those persons who are in possession of a matching key or authorized code may gain entry to the enclosable space.

### 2. Background

It is often desirable to quickly close and lock a door to prevent unwanted passage through the doorway into an interior, enclosable space. An example of such a circumstance is one in which an unwanted intruder attempts to enter a building, which may be any kind of building such as dwelling, a school, a place of work, a place of worship, a movie house, or any other building, or wishes to enter an interior space of such building, for nefarious purposes. In such circumstances, the unwanted intruder often may appear quickly and without any notice or warning. In such circumstances it is desirable that a doorway into the building, or a doorway interior to such a building, be able to be quickly placed into a state that prevents passage through the doorway, such as, for example, a locked or latched state that requires a key or code to allow entry.

It is an attribute of current U.S. society that, from time to time, active shooter or other dangerous situations sometimes occur, without warning, in facilities comprised of a plurality of closeable interior spaces, such as, by way of example and not by limitation, schools. In such situations a dangerous person, who may be, as an example, an active shooter, or any person intending to create harm or damage, may be armed with one or more firearms or other weapons or explosives, and may have the intention of entering the school building in order to inflict physical harm on those persons inside the targeted building. Such targeted buildings may be comprised of a plurality of interior closeable spaces which may be, for example and not by way of limitation, classrooms, media rooms, teacher or administrative offices or other rooms. These closeable spaces typically have doorways that present an opportunity for safely protecting persons inside the room, if a system and method existed that would allow the door to such a room to be quickly closed and locked from the inside, without the need for any tools, keys or other devices, that would very securely place the door into a locked position so as to impede or prevent entry of a dangerous person.

In many such dangerous person situations, a mere impediment in allowing the shooter to gain access into a room could provide time enough for first responders to arrive and engage the dangerous person, who, by way of example and not limitation could be a shooter. Thus, a system and method that is quickly operable, without the need for any tools, that delays or prevents unwanted access through a doorway may allow sufficient time for first responders to arrive to engage and neutralize the shooter. The key element of such systems is that they should be quickly and reliably operable by the inhabitants of the room, and that they deny or delay access to the unwanted intruding dangerous person.

Given the increasing occurrence of active shooter situations, such systems, devices and methods are needed. Specifically, what is needed in the art is an apparatus and/or method adapted to allow a person inside an enclosable space comprising a doorway to quickly close the door that provides entry into the room or building and allows such door to be quickly lockable, such that an unwanted prospective intruder is denied access through a door and into a room, building or any type of enclosed space into which ingress and egress occur through a door or gate. It is also desirable that the door be unlockable from outside the enclosable space only by authorized users, and that the door may be both locked and unlocked from within the enclosable space by user without the need for any key, tool or other device.

### BRIEF SUMMARY OF THE INVENTION

The present invention comprises an apparatus and method that have one or more of the following features and/or steps, which alone or in any combination may comprise patentable subject matter.

It is an object of the invention that, when desired by an user inside an enclosable space, entry into the enclosable space by an unwanted person through a doorway into the enclosable space may be prevented by the user from inside the enclosable space, without the need for a key or any tool, by simple one-step manual operation of a door securing device. The door may be locked by a user from inside the enclosable space using only a foot or finger press to operate the door securing device into a locked state, in one step.

It is an object of the invention that, when a door to an enclosable space has been placed in a locked state by a user from inside the enclosable space, the door may also be unlocked by a user from inside the enclosable space with only one simple manual step. The door may be unlocked by only a foot or finger press, without the need for a key or any tool, i.e. in one manual step.

It is an object of the invention that, when a door to an enclosable space has been placed in a locked state by a user from inside the enclosable space, it may be unlocked by a user from outside the enclosable space only by operation of a matching key.

It is an object of the invention that is easy to install on existing doors including hinged doors and sliding doors.

The present invention overcomes the shortcomings of the prior art in that it is adapted to allow a person inside an enclosable space comprising a doorway to quickly close a door that provides entry into the enclosable space and allows such door to be quickly lockable such that an unwanted person or intruder is denied access through the door and into the enclosable space. The invention may quickly be placed into a locked state that securely prevents passage through the doorway by a quick and simple, manual, one step procedure in which a user pressing on a surface of a locking post such that the locking post is motivated in a direction towards a receiving structure, and a distal end of the locking post either enters a receiving recess, or hole, located in the receiving structure, which may be, for example, a floor of the building or room; or, alternatively, a foot on a proximal end of the locking post comes into contact with the receiving structure, preventing the door from opening due to friction force between the locking post foot and the receiving structure. Thus the locking post may be securely received by the receiving structure to place the door in a locked state, preventing the door from being opened from outside the enclosable space without a key that matches a keylock, or, in the case of an electric keylock, unless an authorized code or signal is received by the keylock. The locking post may be of any diameter but is preferably of substantial diameter, for example and not by way of limitation, ⅜ inches diameter or greater, and may be comprised of a high strength material such as a metal, for example steel, so that the force required to cause the locking post to fail under shear stresses from an unwanted prospective intruder would need to exceed the force that could reasonably be expected to be applied by an intruder, for example, 5,000 pounds or more.

In embodiments, the receiving recess that receives a distal end of the locking post may be of opening shape that is complementary to the cross section of the locking post, and may be strengthened by a plate comprising an opening of the same complementary shape that is secured to an upper surface of the structure underneath the door, which may be for example, a floor, in order to protect the edges of the receiving recess such that the invention does not fail, i.e. allow opening of the door, due to unwanted material failure at or around the edges of the receiving opening.

In embodiments, the locking post may be spring-loaded such that is biased to be motivated in an upward direction towards an unlocked state in which the locking post is motived out of the receiving recess in the receiving surface, or in other embodiments, motivated away from the receiving surface such that the locking post foot is no longer in contact with the receiving surface, allowing the door to be opened. The locking post may be motivated towards a locking position by, for example, the foot or hand of a user, such that the locking post is motivated against the upward biasing force, into a locked state in which, in embodiments, the distal end of the locking post has entered and is received by the receiving recess which may be located in the receiving structured and disposed to receive the locking post when the door is in a closed state and locked state, or, alternatively in other embodiments, the locking post foot is brought into contact with the receiving surface, preventing the door to be opened due to friction forces between the locking post foot and the receiving structure.

In embodiments, the invention may comprise a spring-loaded latching mechanism that operates to latch the locking post in a locked state. The spring-loaded latching mechanism operates to force the interior surfaces of a hole disposed in a canted latch plate, angled at an angle α from an axis of the locking post, against the outer perimeter of the locking post in such an manner as to cause sufficient friction at at least one point of contact between a side of the hole in the canted latch plate and the outer perimeter of the locking post to overcome a first biasing force on the locking post imposed by a first spring, keeping the locking post from being motivated away from the locked position by the first biasing force. However, when any unlatching force is applied to the canted latch plate such that the canted latch plate is rotated reducing angle α, the friction at the at least one point of contact between a side of the opening in the canted latch plate and the outer perimeter of the locking post is reduced or removed, allowing the first biasing force to motive the locking post away from the locked state in which the distal end of the locking post is motivated away from the receiving structure, placing the securing device in an unlocking state, thus allowing the door to be opened. The unlatching force may be a force applied directly to the latch plate by the fingers, hand or foot of a user from the inside the enclosed space, or may be applied by rotating a rectangular tang protruding from an key lock mechanism that is mounted to the door.

In embodiments, the invention may comprise a keylock that is mounted to an outdoor surface of the door that is operable by a manual key or electronic codes that may be input by a user causing a motor to rotate the rotating tang, or other apparatus to rotate a rectangular tang for the purposes of unlatching the locking post, allowing the locking post to motivated in an direction away from the receiving structure and unlocking the door, allowing the door to be opened by a key or code from outside the door. A command to unlock the door may be received wirelessly such as by an RF signal.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating the preferred embodiments of the invention and are not to be construed as limiting the invention. In the drawings:

FIG. 1 depicts a perspective exterior or “outside” view of a doorway in which the door is on a closed state, preventing unwanted entry into an enclosable space.

FIG. 2 depicts a side view of a door upon which a door securing device of the invention has been attached, showing the door securing device of the invention in a latched state and the door in a closed state.

FIG. 3 depicts an orthogonal view from the indoor perspective, showing a door securing device of the invention in a latched state and the door in a closed state.

FIG. 4 depicts a cross sectional side view of a door upon which a door securing device of the invention has been attached, showing the door securing device of the invention of the invention in a latched-down state and the door in a closed and locked state. In this state, the door cannot be opened by a person from outside the door, unless that person has a matching key 003.

FIG. 5 depicts an end view of the rotating tang in an un-rotated state, when a door securing device of the invention is in a locking state.

FIG. 6 depicts a cross sectional side view of a door upon which a door securing device of the invention has been attached, showing the door securing device of the invention in an latch-up state due to operation of a key in the key lock, the door being shown in a closed but unlocked state, so that the door is able to be opened from outside without a matching key 003.

FIG. 7 depicts an end view of the rotating tang after it has been rotated, when a door securing device of the invention is in an unlatched state.

FIG. 8 depicts a cross sectional side view of a door upon which a door securing device of the invention has been attached, showing the door securing device of the invention of the invention in a latched-down state and the door in a closed and locked state, showing an optional configuration for the latch post foot that does not require a receiving hole in receiving structure 200. In this state, the door cannot be opened by a person from outside the door, unless that person has a matching key 003.

FIG. 9 depicts a cross sectional side view of a door upon which a door securing device of the invention has been attached, showing the door securing device of the invention in an latched-up state due to operation of a key in the key lock, the door being shown in a closed and unlocked state, so that the door is able to be opened by a person from outside the enclosed space without a matching key 003, showing an optional configuration for the latch post foot that does not require a receiving hole in receiving structure 200.

In the figures, like callouts refer to like features.

### DETAILED DESCRIPTION OF THE INVENTION

The following documentation provides a detailed description of the invention.

As used herein, “door” and “door to be secured” includes within their meanings any structure that operates to occlude an opening that may be used by a person for ingress into or egress into or out of an enclosable space such as a room, enclosed structure or area, or building. “Door” and “door to be secured” includes within their meanings any and all equivalent structures such, for example and not by way of limitation, gates, French doors, sliding glass doors, and any structure that is operable to occlude an opening into an enclosable space.

As used herein, “enclosable space” includes within its meaning any space that may be enclosed by the closing of a door. Non-limiting examples of enclosable spaces are interior rooms of buildings, buildings themselves, auditoriums, classrooms, bathrooms, closets, outdoor sheds, barns, armories, warehouses.

As used herein, “intruder”, “shooter”, “unwanted person” and “dangerous person” include within their meanings any person for whom it is desired to prevent entry into an enclosable space.

As used herein, “keylock” is any device that comprises a rotatable tang operable to rotate between a rotated or an un-rotated position when either commanded by receipt of a code or signal in the case in which the keylock comprises an electric motor for rotating the rotatable tang, or, in the case of a manual keylock, when a matching key is inserted into the keylock rotated in the keylock. The keylock rotatable tang has a “rotated” position, and an “un-rotated” position. The keylock is operable such that a matching key may be inserted and the rotatable tang may be rotated between the rotated and un-rotated positions by rotation of the matching key in the keylock. The matching key may be removed from the keylock when the rotatable tang is in either the rotated or un-rotated position. Thus a matching key may be inserted into the keylock and the rotatable tang may be rotated into either the rotated or un-rotated position, and the key removed. A key that is not a matching key is not operable to rotate the rotatable tang. Thus a matching key 003 may be used to place the door securing device of the invention into state in which the door is unlocked and is able to be opened. In embodiments, a user is not able to place the door securing device of the invention into a locked state using matching key 003.

As used herein, the door securing device of the invention 001 is in a “locking state” when locking post 100 has been motivated toward receiving structure 200 such that door 002 is unable to be opened either because a distal end of locking post 100 has been received by, and has protruded into, receiving opening 201, or a distal end of locking post 100, which may comprise a foot 300, is pressed against receiving structure 200 with sufficient force that the friction force generated by the pressing of the distal end or foot of locking post 100 against receiving structure 200 is sufficient to overcome an applied door-opening force.

As used herein, the door securing device 001 of the invention is in an “unlocking” state when locking post 100 has been motivated away from receiving structure 200 such that door 002 is able to be opened.

As used herein, “indoor” and “inside” mean within the enclosable space, and “outdoor” and “outside” mean outside of the enclosable space.

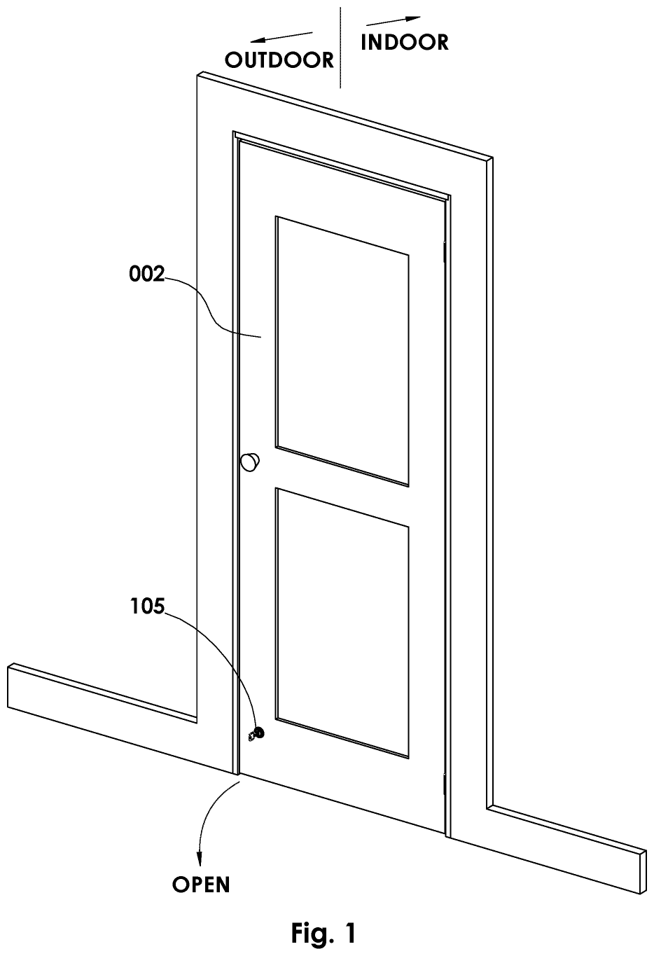

Referring now to FIG. 1, a perspective view of an application of the door securing device of the invention 001 is depicted. Door 002 is shown in a closed state, in which access to an enclosable space located on the INDOOR side of door 002 is blocked. Door 002, when unlocked, is able to be opened to provide access to an enclosable space located on the “indoor” side of the door. The view of FIG. 1 is taken from the outdoor, or exterior, side of door 002, i.e., outside the enclosable space. This is the side of the door from which an unwanted intruder may typically seek to enter the enclosable space. Keylock 001, may be, but is not necessarily, located towards a lower end of a door to be secured. Keylock 001 may also be located on a side of door 002. Keylock 001 may be operable to receive a matching a key 003 for unlocking door 002 when door 002 has been secured by the door securing device of the invention in a locked state. Door 002 may, when in an unlocked state, be openable as indicated by the OPEN arrow in FIG. 1. In use, a user located on the indoor, or interior, side of door 002, i.e. a user located inside the enclosable space, may be alerted by any means to the presence of an unwanted person or intruder who may attempt to gain access to the enclosable space via door 002. Such a user located inside the enclosable space may then operate the door securing device of the invention as described below to place door 002 in a locked state, denying access to the unwanted intruder, which may result in delaying or completely preventing the unwanted person or intruder from entering the enclosable space through door 002 until such time as help may arrive in the form of first responders or other authorized personnel. Such authorized personnel may insert a matching key 003 into keylock 001 once the threat of the unwanted person has been removed, and then rotate matching key 003, thereby unlocking door 002 so that it may be opened from outside the enclosable space.

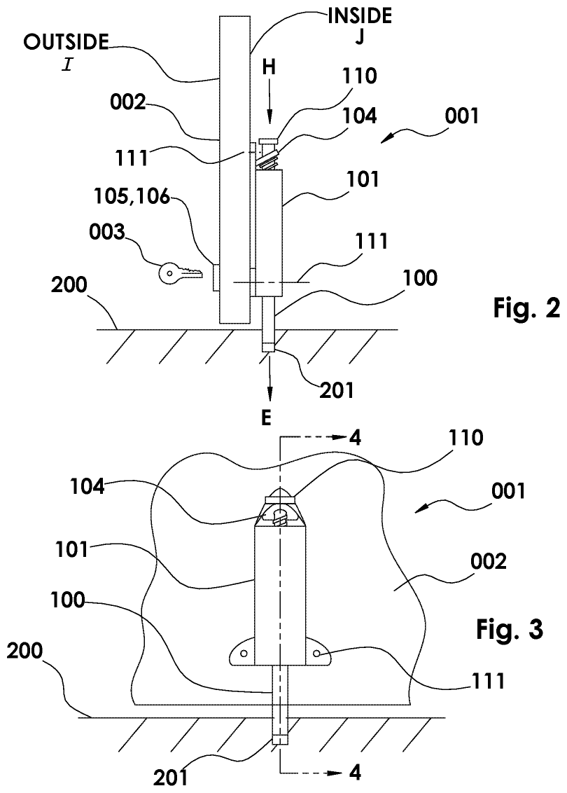

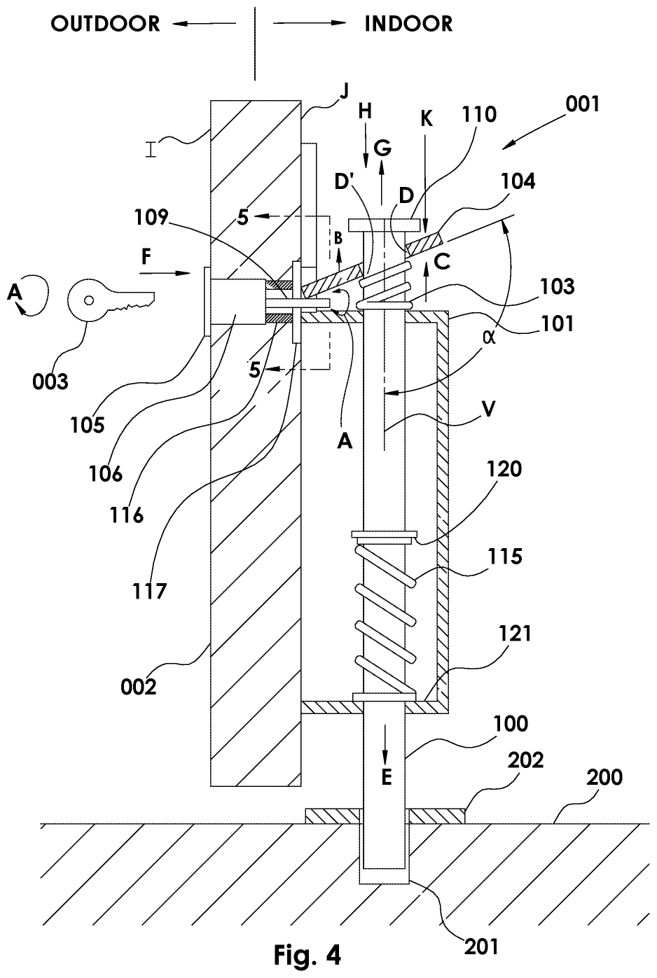

Referring now to FIG. 2, a side view of a door 002 upon which an embodiment of a door securing device of the invention 001 has been attached, showing the door securing device of the invention 001 in a locking state and the door in a closed and locked state, is depicted. The door securing device 001 of the invention may comprise housing 101 that may be mounted to an interior, or indoor side of the door J. The inside side of door 002 may face into the enclosable space. Housing 101 may contain a compression spring 115 (shown in FIG. 4) that acts upon locking post 100, causing locking post 100 to be subject to a first biasing force G as is further depicted in FIGS. 4, 6, 8 and 9. A user may manually motivate locking post 100 by an applied force H, which may be applied for example by a finger, foot or hand of a user, in the direction of arrow E so that locking post 100 is motivated into a receiving recess 201 that may be located in a floor, door frame or other receiving structure 200. Housing 101 may be secured to indoor side of door 002 by mounting hardware 111, such as, for example and not by way of limitation, threaded fasteners, which may be used to secure flanges or other mounting features disposed on housing 101 to door surface J. Keylock 106 may have an exterior flange 105 that supports keylock 106 and holds it firmly against the outdoor, or outside, surface I of door 002. Matching key 003 may be used to unlock the door to be secured 002 from outside the enclosed space by inserting matching key 003 into keylock 106 and rotating matching key 003. Locking post 100 may comprise a surface 110 of greater surface area than the diameter of the locking post located on an proximal end of the locking post 100, which surface 110 may optionally comprise a nonskid texture that may assist a user in gripping or placing a hand or foot onto locking post 100 and order to manually motivated into the latched position shown in the figure. Latch plate 104 is depicted for reference.

Referring now to FIG. 3, an orthogonal view from the indoor perspective, showing a door securing device of the invention 001 in a locking state and the door 002 in a closed and locked state is depicted. Housing 101 may be securely attached to an indoor, or interior, side J of a door to be secured 002. A user may manually motivate locking post 100 by an applied force H on surface 110, as depicted in FIG. 2, which may be applied for example by a finger, foot or hand of a user, in the direction of arrow E as shown in FIG. 2 so that locking post 100 is motivated into a receiving recess 201 that may be located in a floor, door frame or other receiving structure 200. Housing 101 may be secured to indoor side of door 002 by mounting hardware 111, such as, for example and not by way of limitation, threaded fasteners. Latch plate 104 is depicted for reference.

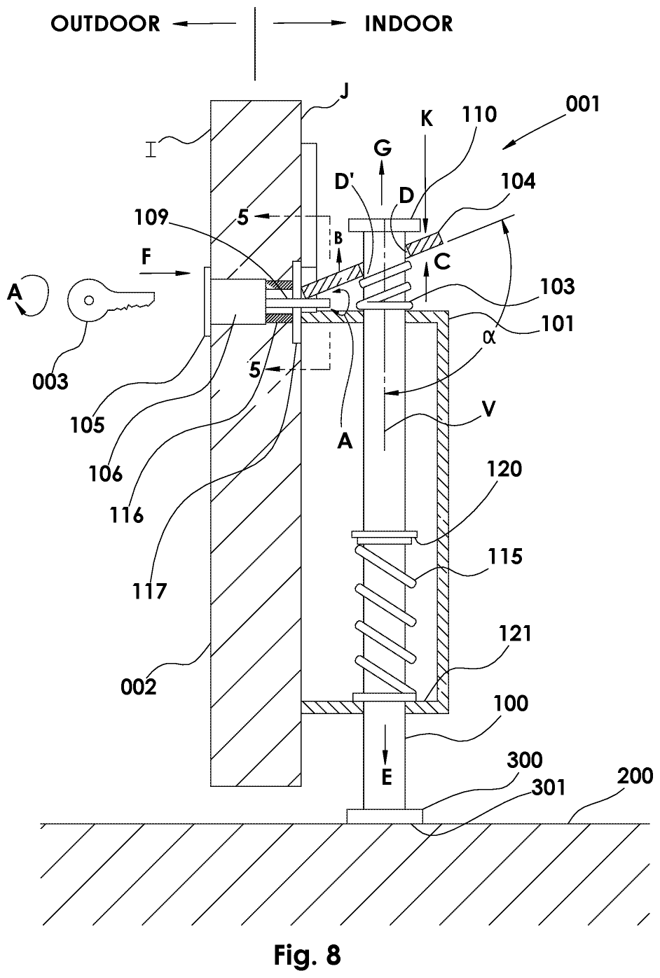

Referring now to FIGS. 4 and 8, a cross sectional side view of a door 002 upon which an embodiment of a door securing device the invention 001 has been attached, showing the door securing device of the invention in a latched state and the door in a closed and locked state is depicted. In the latched state, latch plate 104 prevents lokcing post from being motivated away from receiving surface 200, causing the door securing device to remain in a locking state, and thus door 002 to remain in a locked state, until the spring-loaded friction latch of the invention is unlatched as described herein. Referring now to FIG. 4, locking post 100 has been motivated in the direction of arrow E by a user from inside the enclosable space by the application of a force H on surface 110, against first biasing force G, such that locking post 100 distal end has been received by receiving recess 201 which is disposed in a structure located underneath the door to be secured 002, placing door 002 in a locked state, meaning that door 002 cannot be opened from outside the enclosable space unless it is placed in unlocked state as described herein. A plate 202 may be located on the surface of receiving structure 200, having a hole there through so that the distal end of locking post 100 may pass through plate 202 to be received by receiving recess 201. Plate 202 may be utilized to prevent damage to the opening of receiving recess 201 in receiving structure 200 by repeated use of the door securing device of the invention. Alternatively, FIG. 8 depicts an embodiment of the invention which does not require a receiving recess 201 in receiving structure 200. In this embodiment, stop 300 is disposed on a distal end of locking post 100 such that, which the latch is placed in a latched-down state by a user from inside the enclosable space, the door 002 is locked and prevented from being opened by operation of friction between foot 300 and receiving structure 200 where they are in contact at area 301. The embodiment of FIG. 8 may be preferable in those situations in which it is not feasible or desirable to create receiving recess 201 in the surface of structure 200 which may require, for example, drilling into cement or concrete.

Still referring to FIGS. 4 and 8, an unwanted intruder or other person located on the outdoor side of door 002 is unable to open door 002 because of the locking operation provided by the insertion of the distal end of locking post 100 into receiving recess 201, or by the friction between foot 300 and receiving structure 200 where they are in contact at area 301. A first biasing force G acting on locking post 100 is produced by compression spring 115 acting between surface 120 of housing 101 and surface 121 of locking post 100. Surface 121 may be a surface that forms a part of, either directly or indirectly, housing 101. Surface 120 may be an underneath surface of a plate, pin or other structure that is attached to locking post 100. The first biasing G force tends to push locking post 100 in the direction of arrow G. Thus, when a force K is applied to a latch plate 104 as indicated, or when key 003 is rotated in keylock 106 as indicated by arrow A causing rotating tang 109 to be rotated which in turn forces latching plate 104 upward in the direction of arrow B, the frictional forces produced by the canted angle α of latching plate 104 relative to the axis V of locking post 100 and second biasing force acting on latching plate 104 are reduced to the point that they are overcome by first biasing force G operating in the direction of arrow G, which allows the locking post 100 to be motivated in the direction of arrow G, placing the door securing device of the invention in an unlocking state, placing door 002 in an unlocked state, and allowing the door to be opened as further depicted in FIG. 6.

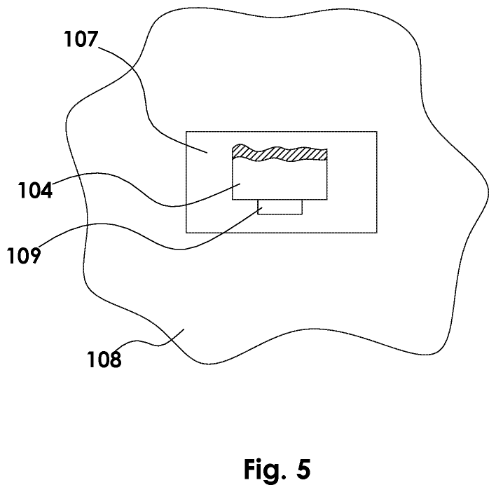

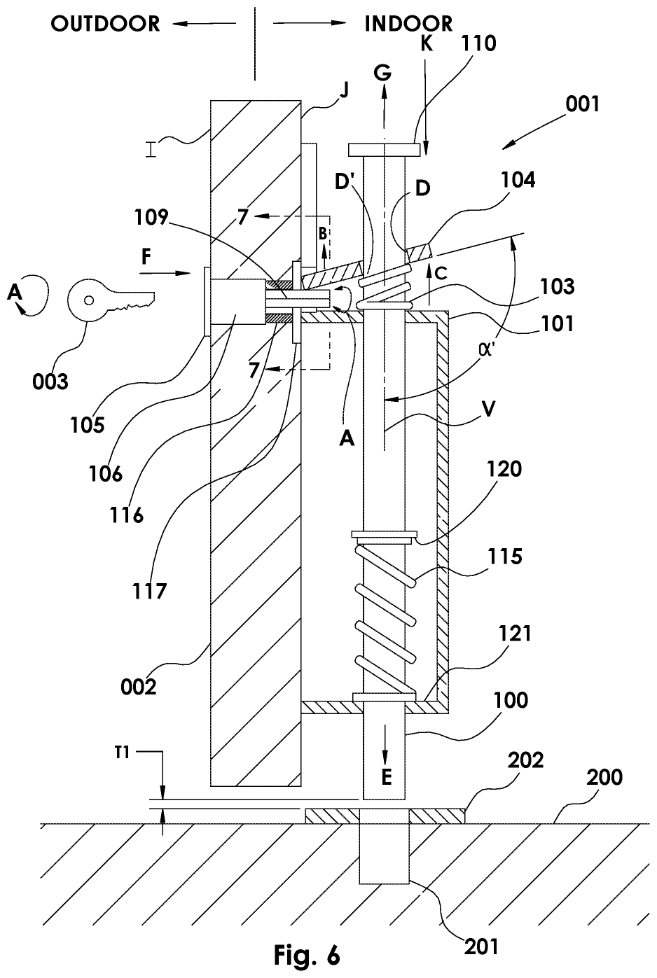

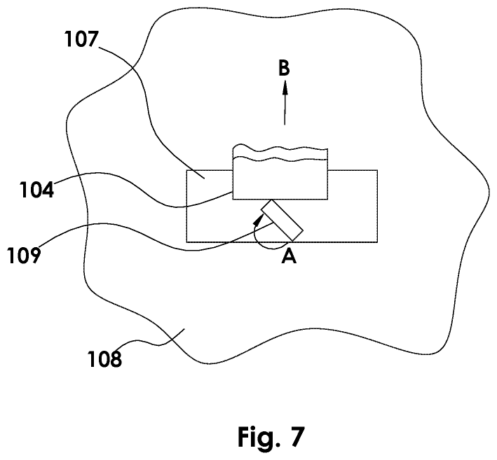

Still referring to FIGS. 4 and 8, a spring-loaded friction latch comprising a latch plate 104 having an opening, where locking post 100 passes through the opening, and the opening in latch plate 104 being slightly larger than a perimeter of locking post 100, is depicted. The spring-loaded friction latch operates to latch locking post 100 in a locking state until the spring-loaded friction latch is unlatched. When the spring-loaded friction latch is unlatched, the locking post is allowed to be motivated away from receiving structure 200 as described herein. Latch plate 104 is biased by a second biasing force operating in the direction of arrow C, the second biasing force being provided by compression spring 103 that operates to apply the second biasing force on latch plate 104, the second biasing force tending to motivate latch plate 104 in the direction of arrow C and at an angle α to locking post 100 axis V. This second biasing force causes latch plate 104 to be motived at an angle α to locking post 100 axis V, creating points of contact friction between the opening in latch plate 104 through which locking post 100 passes and the perimeter of locking post 100 at points D and D′, causing a resulting frictional force between the opening in latch plate 104 and the perimeter of locking post 100 that is sufficient to overcome the first biasing force G, preventing the translation of locking post 100 in the direction of arrow G unless a force K is applied to a distal end of latch plate 104 as shown, for instance by the thumb or finger, or foot, of a user; or unless latching plate 104 is motivated upwards in the direction of arrow B by the rotation of rotating tang 109 caused by the insertion of matching key 003 into keylock 106 along the direction of arrow F and the rotation of key 003 in keylock 106 along arrow A, in either direction. The operation of rotating rectangular tang 109 to unlatch the door securing device 001 and place the door securing device of the invention 001 into an unlocking state is further described below and depicted in FIGS. 5 and 7. It is the rotation of rotating tang 109 causing force B on latch plate 109 when rotating tang 109 is rotated by the rotation of key 003 in keylock 106 that reduces the angle α between latching plate 104 and the axis of locking post 100, which in turn reduces friction at points D and D′ between the opening in latching plate 104 through which locking post 100 passes and the perimeter of locking post 100, allowing the first biasing force G to overcome the resulting force of friction at points D and D′, unlatching locking post 100 and allowing locking post 100 to be motivated in the direction of arrow G by the first biasing force G. Latch plate 104 may be retained in place by operation of force C pressing latch plate 104 against an underneath surface of the feature of locking post 100 that forms surface 110, which may be larger in outside dimension than the opening in latch plate 104 that allows locking post 100 to pass through the opening in latch plate 104. Latch plate 104 may also be additionally retained by the passing of locking post 100 through the opening in latch plate 104, and the operation of a portion of latch plate 104 protruding in opening 150 in housing 101 or housing flange that allows rotating tang 109 to pass through opening 150 in housing 101 or the housing flange and to come into contact with latching plate 104.

Still referring to FIGS. 4 and 8, keylock 106 may be secured in the door 002 by threaded fasteners 116 which may be captured in counter sunk or other holes located in keylock mounting plate 117. This is but an exemplary configuration for securing keylock 106 into door 002. Keylock 106 may be secured into door 002 by any means known in the art which prevents the removal or disassembly of keylock 106 from the outdoor side of door 002. Keylock 106 exterior flange 105 is shown for reference.

Referring now to FIG. 5, an end view of an embodiment of rotating tang 109 in an un-rotated state is depicted. Rotating tang 109 may be, but is not necessarily, rectangular in cross-section and is in contact with a surface of the latching plate 104. Rotating tang 109 passes through opening 107 in flange 108 which may form a part of housing 101. When rotated, rotating tang 109 operates on latching plate 104 to force its end in the direction of arrow B as is discussed further in FIGS. 6 and 7.

Referring now to FIGS. 6 and 8, a cross sectional side view of a door 002 upon which an embodiment of a door securing device the invention 001 has been attached, showing the door securing device of the invention in an unlocked state such the door may be opened, is depicted. Locking post 100 has been motivated in the direction of arrow G by the first biasing force, either because the rotation of key 003 in keylock 106 and the resulting rotation of rotating tang 109 have resulted in force B on latch plate 104, which reduces angle α of latch plate 104 relative to locking post axis V; or because a force K has been applied to a distal and of latch 104, for instance by the thumb or finger, or foot, reducing angle α of latch plate 104 relative to locking post axis V to α′, which is less than angle α; which, in either case, reduces the friction forces at contact pressure at points D and D′, allowing the first biasing force G to overcome the resulting frictional forces at D and D′, and allowing first biasing force G to motivate locking post 100 in the direction of G. Thus, referring specifically to FIG. 6, locking post 100 has been motivated in the direction of G such that its distal end is no longer received by receiving recess 201 which is disposed in a structure located underneath the door to be secured 002. Alternatively, referring specifically to FIG. 8, locking post 100 has been motivated in the direction of G such that its distal end, or foot 300, is no longer in contact with receiving surface 200, and thus there are no frictional forces acting at 301 to resist door 002 being opened. As depicted in FIGS. 6 and 8, the door securing device 001 of the invention is now in an unlocked state, and door 002 is able to be opened from the outdoor side, i.e. outside the enclosable space.

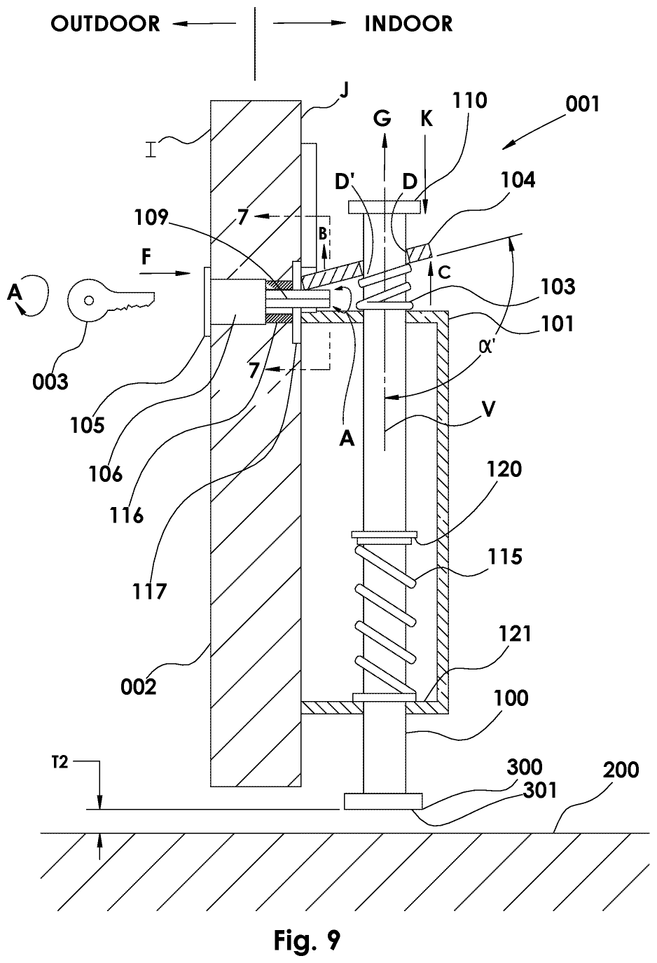

Still referring to FIGS. 6 and 8, the spring-loaded friction latch operating on locking post 100, comprising a latch plate 104 having an opening, where locking post 100 passes through the opening, and the opening in latch plate 104 is slightly larger than a perimeter of locking post 100, is depicted. Latch plate 104 is biased by a second biasing force C operating in the direction of arrow C, the second biasing force being provided by compression spring 103 that operates to apply the second biasing force on latch plate 104, the second biasing force tending to motivate latch plate 104 upwards in the direction of arrow C. This second biasing force causes latch plate 104 to be motived at an angle α to the axis of locking post 100 creating points of contact friction between the opening in latch plate 104 through which locking post 100 passes and the perimeter of locking post 100 at points D and D′, causing a resulting frictional force between the opening in latch plate 104 and the perimeter of locking post 100 that is sufficient to overcome the first biasing force G and preventing the translation of locking post 100 in the direction of arrow G unless a force K is applied to a distal and of latch 104 as shown, for instance by the thumb or finger, or foot, of a user; or unless latching plate 104 is motivated upwards in the direction of arrow B by the rotation of rotating tang 109 by the insertion of key 003 into keylock 106 along the direction of arrow F and the rotation of key 003 in keylock 106 along arrow A, which rotation may be in either direction. The operation of rotating rectangular tang 109 to place the door securing device of the invention 001 into an unlocked state is further described below and depicted in FIG. 7. In embodiments, a surface of rotating tang 109 that rotates against a surface of latch plate 104 where they come into contact, producing a force on latch plate 104 in the direction of arrow B when rotating tang 109 is rotated by the rotation of key 003 in keylock 106 that reduces the angle α between latching plate 104 and the perimeter of locking post 100 to α′, which in turn reduces friction at points D and D′ between the opening in latching plate 104 through which locking post 100 passes and the perimeter of locking post 100, allowing the first biasing force in the direction of arrow G to overcome the reduced force of friction at points D and D′, and allows locking post 100 to be motivated in the direction of arrow G by the first biasing force, placing the door securing device of the invention 100 into an unlocked state by either removing the distal end of locking post 100 from receiving recess 201 in receiving structure 200 as depicted by clearance T1 in FIG. 6, or by removing locking post distal end or foot 300 located on distal end of locking post 100 from the surface of receiving structure 200 as depicted by clearance T2 in FIG. 9 thus removing the friction forces at 301 that operate to resist the opening of door 002, so that door 002 is placed in an unlocked state where it may be opened by a user from outside the enclosable space by a user.

Referring now to FIG. 7, an end view of the rotating tang 109 after it has been rotated as depicted by arrow A, when a door securing device of the invention is in an unlocked, is depicted. When rotated by the rotation of matching key 003 in keylock 106, rotating tang 109 contacts and operates on latching plate 104 to force latching plate 104's end slightly upward in the direction of arrow B, reducing the angle α between latching plate 104 and the axis of locking post 100 to angle α′, which in turn reduces friction at points D and D′ between the opening in latching plate 104 through which locking post 100 passes and the perimeter of locking post 100, allowing the first biasing force in the direction of arrow G to overcome the resulting force of friction at points D and D′, and allows locking post 100 to be motivated in the direction of arrow G by the first biasing force.

In embodiments, the keylock may comprise an electric motor operable to rotate rotating tang 109. The motor may be controllable by the inputting of an electronic code into a user input, such as a keypad that is communication with a controller, that may be input by a user causing a motor to rotate the rotating tang such that the securing device is placed into an unlocked state by the rotation of rotating tang 109 as described herein, allowing the locking post to be motivated in an direction away from the receiving structure and unlocking the door. The code may be received wirelessly by a wireless receiver in communication with the controller. The controller may be in communication with the motor such that input codes, entered either manually or wirelessly by, for example, a Radio Frequency signal, instruct the controller to rotate the motor, which causes rotation of the rotatable tang thus placing the door in an unlocked state. Electric power may be communicated to the receiving, controller and motor by batter or by electrical wiring that is in communication with a power source, traversing one of the door hinges. Thus, in embodiments, the door to be unlocked by entry of a code from outside the door, or receipt of a wireless signal.

A method for using the invention comprises the following steps. The operation of the invention is discussed in two phases: the door locking phase, and the door unlocking phase.

In the door locking phase, the inhabitants of an enclosable space may first be made aware of the presence of an unwanted prospective intruder. This may be by any alert means known in the art, such audio or visual alarms, intercom, phone, or other means. Next, a person from inside the enclosable space closes the door 002 that provides entry into the room, if the door is not already in a closed state. Once the door 002 is closed, the user, still on the indoor side of the door 002, motivates the locking post 100 into either the receiving recess 201 in receiving structure 200, or until door stop 300 is firmly pressed against receiving structure 200 by applying a force H by finger, hand, foot or any other available means on surface 110. This places the door in a locked state in which it cannot be opened by a person from outside the enclosable space. Latch plate 104 is biased into a latching position by the second biasing force created by latch spring 103 against the perimeter of the locking post 100 creating friction at points D and D′, which overcomes the first biasing force on the locking post created by compression spring 115, and causes locking post 100 to remain latched and protruding into the receiving recess 201. The door 002 is now closed and locked, and the door securing device is latched in a locking position, and the door 002 is unable to be opened from the outdoor side without access to a matching key 003.

In the unlocking phase, there are two possible scenarios. In a first scenario, the door is unlocked from inside the enclosable space by a user, for example, after an all clear signal has been given. In this scenario, a user from inside the enclosable space, for example from inside the room or building, operates the latching plate 104 downwards by manually pressing on it by hand, finger, foot or otherwise, reducing or removing the latch plate 104 friction on the locking post 100 at points D and D′, allowing the first biasing force on the locking post 100 to motivate the locking post 100 upwards into an unlocked state in which the distal end of locking post 100 has been motivated out of receiving recess 201, or alternatively door stop 300 is no longer in contact with against receiving structure 200. The door 002 is now unlocked and is able to be opened from the outdoor or indoor side. In a second scenario, persons inside the enclosable space may not be able to know or to ascertain when the all clear signal has been given, or may simply be under instruction to stay locked in the room until the door is opened from the outside by law enforcement or other authorized personnel. In this scenario, an authorized person on the outside the enclosable space may insert a matching key 003 into a receiving keyhole disposed in keylock 106, and may then rotate the matching key 003, causing the rotating tang 109 to rotate into a rotated position, reducing the latching friction between the opening in the latching plate 104 and the perimeter surface of the locking post 100 at points D and D′, allowing the first biasing force on the locking post 100 to motivate the locking post 100 into an unlocked state in which the distal end of locking post 100 has been motivated out of receiving recess 201, or alternatively door stop 300 is no longer in contact with against receiving structure 200. The door is now unlocked and able to be opened from the outdoor or indoor side.

In embodiments of the invention, the distal end of the locking post 100 may comprise a foot 300, and rather than be inserted into a receiving recess 201 when in a latched state, foot 300 may simply be forced downward and held against the receiving structure 200 such that the friction created by the pressure applied by foot 300 to the receiving structure 200 is sufficient to keep the door secured from opening when a force is applied to door 002 from outside the enclosable space by an unwanted person or intruder. Foot 300 may be fabricated from any material such metals, durable plastics, or rubber. The surface 301 may comprise a compressible or non-scratching material, such as for example, rubber, such that receiving surface 200 is not likely to be scratched or marred when locking post 100 is in the locking position in which surface 301 is pressed against receiving surface 200 with sufficient force such that the friction between surface 301 and receiving surface 200 is able to resist an applied opening force or impact applied to a surface of door 002 from outside the enclosable space. Such applied opening force may, for example, be 500 pounds or greater. The use of rubber may also provide an increased coefficient of friction between surface 301 and receiving surface 200.

Although a detailed description as provided in the attachments contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus the scope of the invention should be determined by the appended claims and their legal equivalents, and not merely by the preferred examples or embodiments given.

What is claimed is:

1. A securing device for a door that allows entry into an enclosable space, comprising:
a locking post, said locking post subject to a first biasing force, and said locking post able to be motivated against said first biasing force by a user, wherein when said locking post is motivated by a user against said first biasing force by a user, said locking post is received by a receiving structure, placing said securing device in a locking position such that, when said distal end of said locking post is received by a receiving structure, a door upon which said securing device is attached is placed in a locked state;
a spring-loaded friction latch comprising a latch plate having an opening, said locking post passing through said opening, said opening slightly larger than a perimeter of said locking post;
said spring-loaded friction latch subject to a second biasing force that forces said latch plate against said perimeter of said locking post at an angle, forming at least one point of friction contact between an inside surface of said opening and said perimeter of said locking post, said friction producing a resulting force on said locking post preventing said locking post from being motivated by said first biasing force; and
a keylock having a rotatable tang such that rotation of a matching key in said keylock causes a surface of said rotatable tang to rotate against a surface of said latch plate, displacing said latch plate so as to reduce said angle such that said friction at said at least one point of contact between inside surface of said opening and said perimeter of said locking post is reduced, allowing said locking post to be motivated by said first biasing force away from said receiving recess, placing a door upon which the securing device is mounted into an unlocked state;
wherein said key may be inserted into said keylock from outside said enclosable space; but said locking post and said spring-loaded friction latch are not accessible from outside said enclosable space.

2. The securing device of claim 1 in which said first biasing force and said second biasing force are provided by compression springs.

3. The securing device of claim 1 in which said receiving structure receives said distal end of said locking post in a receiving recess located in said receiving structure.

4. The securing device of claim 1 in which said receiving structure is a floor underneath a door to be secured.

5. The securing device of claim 1 in which said receiving structure is a side of a door frame adjacent to a door to be secured.

6. The securing device of claim 1 in which, when said locking post is motivated against said first biasing force, said distal end of said locking post is pressed against said receiving structure, creating a friction force between a surface of said distal end of said locking post and a surface of said receiving structured, said friction force able to be resist an opening force applied to said door.

7. The securing device of claim 6, wherein said distal end of said locking post further comprises a foot.

8. The securing device of claim 1, wherein said locking post has a shear strength of 5,000 pounds or greater.

9. The securing device of claim 1, wherein said locking post comprises steel material.

10. The securing device of claim 1, further comprising a controllable motor for rotating said rectangular tang, a source of electric power in communication with said motor, and a controller in communication with said motor, and either a receiver in communication with said controller for receiving a wireless signal commanding said motor to rotate said rectangular tang to place said securing device in an unlocking state, or a keypad in communication with said controller for entry of a code by a user from outside the enclosable space for rotating said rotatable tang and placing said securing device in an unlocking state.

11. A securing device for a door that allows entry into an enclosable space, comprising:
a locking post, said locking post subject to a first biasing force, and said locking post able to be motivated against said first biasing force by a user, wherein when said locking post is motivated by a user against said first biasing force by a user, said locking post is received by a receiving structure, placing said securing device in a locking position such that, when said distal end of said locking post is received by a receiving structure, a door to be secured upon which said securing device is attached is placed in a locked state;
a spring-loaded friction latch comprising a latch plate having an opening, said locking post passing through said opening, said opening slightly larger than a perimeter of said locking post;
said spring-loaded friction latch subject to a second biasing force that forces said latch plate against said perimeter of said locking post at an angle, forming at least one point of friction contact between an inside surface of said opening and said perimeter of said locking post, said friction producing a resulting force on said locking post preventing said locking post from being motivated by said first biasing force; and
a keylock having a rotatable tang such that rotation of a matching key in said keylock causes a surface of said rotatable tang to rotate against a surface of said latch plate, displacing said latch plate so as to reduce said angle such that said friction at said at least one point of contact between inside surface of said opening and said perimeter of said locking post is reduced, allowing said locking post to be motivated by said first biasing force away from said receiving recess, placing a door upon which the securing device is mounted into an unlocked state;
wherein said locking post is retained in a housing for mounting on an inside surface of a door to be secured;
wherein said key may be inserted into said keylock from outside said enclosable space; but said locking post and said spring-loaded friction latch are not accessible from outside said enclosable space.

12. The securing device of claim 11 in which said first biasing force and said second biasing force are provided by first and second compression springs, respectively; and wherein said first compression spring is at least partially compressed between a surface of said housing and a surface of a protrusion of said locking post, said locking post passing through said first compression spring.

13. The securing device of claim 11 in which said receiving structure receives said distal end of said locking post in a receiving recess located in said receiving structure.

14. The securing device of claim 11 in which said receiving structure is a floor underneath a door to be secured.

15. The securing device of claim 11 in which said receiving structure is a side of a door frame adjacent to a door to be secured.

16. The securing device of claim 11 in which, when said locking post is motivated against said first biasing force, said distal end of said locking post is pressed against said receiving structure, creating a friction force between a surface of said distal end of said locking post and a surface of said receiving structured, said friction force able to be resist an opening force applied to said door.

17. The securing device of claim 16, wherein said distal end of said locking post further comprises a foot.

18. The securing device of claim 11, wherein said locking post has a shear strength of 5,000 pounds or greater.

19. The securing device of claim 11, wherein said locking post comprises steel material.

20. The securing device of claim 11, further comprising a controllable motor for rotating said rectangular tang, a source of electric power in communication with said motor, and a controller in communication with said motor, and either a receiver in communication with said controller for receiving a wireless signal commanding said motor to rotate said rectangular tang to place said securing device in an unlocking state, or a keypad in communication with said controller for entry of a code by a user from outside the enclosable space for rotating said rotatable tang and placing said securing device in an unlocking state.
